(19) United States
(12) Patent Application Publication
(10) Pub. No.: US 2017/0002756 A1
(43) Pub. Date: Jan. 5, 2017

(54) A METHOD FOR REMOVING LEAKED CRANKCASE FLUID FROM A CRANKCASE AND A CRANKCASE VENTILATION SYSTEM

(71) Applicant: VOLVO TRUCK CORPORATION, Göteborg (SE)

(72) Inventor: Sergi YUDANOV, Västra Frölunda (SE)

(73) Assignee: VOLVO TRUCK CORPORATION, Göteborg (SE)

(21) Appl. No.: 15/113,150

(22) PCT Filed: Feb. 21, 2014
(86) PCT No.: PCT/EP2014/000459

§ 371 Date: Jul. 21, 2016

(51) Int. Cl. F02D 41/00; F01M 13/04; F01M 13/00

(52) U.S. Cl. CPC F02D 41/0025; F01M 13/0011; F01M 13/04; F02D 2250/08

(57) ABSTRACT

A method is provided for removing leaked crankcase fluid from a crankcase of an internal combustion engine during operation thereof, the method including the steps of measuring as operation parameter value of the internal combustion engine; comparing the measured operation parameter value with a preset parameter range defining a mode of operation of the internal combustion engine for determining if the internal combustion engine is in the mode of operation; guiding the leaked crankcase fluid from the crankcase to an intake of the internal combustion engine if it is determined that the internal combustion engine is in the mode of operation; and guiding the leaked crankcase fluid from the crankcase to an ambient environment of the internal combustion engine if it s determined that the internal combustion engine is not in the mode of operation.

### BACKGROUND AND SUMMARY

The present invention relates to a method for removing leaked crankcase fluid from a crankcase of an internal combustion engine. The invention also relates to a crankcase ventilation system as well as a control unit for controlling an electrically controlled valve of the crankcase ventilation system. The invention is applicable on vehicles, in particularly heavy vehicles, such as e.g. trucks. However, although the invention will mainly be described in relation to a truck, the invention is of course also applicable for internal combustion engines used in other type of vehicles, such as cars, industrial construction machines, wheel loaders, etc.

For internal combustion engines of various types, a problem that often occurs is that vapor leakage is formed in the crankcase during operation from the combustion process of the engine. These vapor leakage needs to be handled in a sufficient and efficient manner such that the crankcase is drained from the leakage. It may not be suitable to redirect the vapor back to the fuel tank and also not to the environment, since this may negatively affect the environment, provide safety hazards as well as negatively affecting the fuel consumption. It is therefore desired to direct the vapor leakage to the internal combustion engine such that it can be safely burned and also partly used for power generation.

According to an example, WO 2012/171593 discloses a fuel system for supplying fuel vapor to an internal combustion engine. The fuel system comprises a housing in which lube oil is provided at a certain fill level. During operation of an internal combustion engine to which the fuel system is connected, fuel vapor from the housing is directed to the combustion chamber of the internal combustion engine. The system further comprises a drain valve and a lube oil supply valve. When the engine is in a non-running state, i.e. when the engine is shut-off, the valves are closed thus preventing fuel leakage from the housing. Hereby, WO 2012/171593 solves the problem of reducing the risk of oil leakage when the engine is turned off, since the drainage of fuel vapor may not function when the engine is turned off due to lack of negative pressure at the intake port of the engine.

The invention disclosed in WO 2012/171593 is however still in need of further improvements in terms of e.g. increased functionalities and oil supply control.

US 2011/0048391 relates to a breather system for a crankcase of an internal combustion engine. The system comprises a pressure regulator which can allow gas to pass into a discharge conduit that can either be directed to atmosphere or can be redirected to the engine intake manifold.

U.S. Pat. No. 3,372,685 relates to a pressure warning system and relief valve for a crankcase of an internal combustion engine. The system comprises a valve assembly provided between the crankcase and a crankcase breather pipe.

It is desirable to provide a method for removing leaked crankcase fluid formed in the crankcase of an internal combustion engine.

According to a first aspect of the present invention there is provided a method for removing leaked crankcase fluid from a crankcase of an internal combustion engine during operation thereof, the method comprising the steps of measuring an operation parameter value of the internal combustion engine; comparing the measured operation parameter value with a preset parameter range defining a mode of operation of the internal combustion engine for determining if the internal combustion engine is in the mode of operation; guiding the leaked crankcase fluid from the crankcase to an intake of the internal combustion engine if it is determined that the internal combustion engine is in the mode of operation; and guiding the leaked crankcase fluid from the crankcase to an ambient environment of the internal combustion engine if it is determined that the internal combustion engine is not in the mode of operation.

The wording “operation parameter” should in the following and throughout the entire description be interpreted as a parameter of the internal combustion engine which is measured when the internal combustion engine is running, i.e. when the internal combustion engine is operated. Furthermore, the wording “preset parameter range” should be interpreted as a range for a parameter corresponding to the measured parameter value, such that a comparison between the operation parameter value and the preset parameter range is made for similar parameters. Also, according to an example embodiment, the preset parameter range may be interpreted as a range which defines an operational mode of the engine when the engine is running at a normal operation, i.e. when the engine is running as expected under the specific conditions at the specific point in time when the measurement is made.

Furthermore, the wording “leaked crankcase fluid” should not be construed as limited to a specific phase or type of the fluid. The leaked crankcase fluid may be in a gas phase or in a liquid phase. The leaked crankcase fluid may, for example, contain blow-by gas, fuel vapor, oil mist etc. Furthermore, the leaked crankcase fluid is a fluid formed in the crankcase during operation of the internal combustion engine, i.e. during the combustion process.

As an example, if the parameter is related to e.g. the exhaust temperature, as will be described below, the method according to the invention measures an exhaust temperature at a specific point in time. The measured exhaust temperature is then compared to a preset parameter range defining a mode of operation of the internal combustion engine, which in the specific example is a temperature range in which it is expected that the exhaust is exposed to under the circumstances of the present engine operation. In this example, the mode of operation is hence the preset temperature range. If the measured temperature is not within the range, then it is determined that the internal combustion engine is not in the mode of operation and the leaked crankcase fluid is guided to the ambient environment of the internal combustion engine instead of to the intake of the internal combustion engine.

It should be readily understood that the preset parameter range may vary depending on the specific parameter measured. In fact, the range may even be so small that it can be considered as a specific value.

The present invention is based on the insight that by guiding leaked crankcase fluid from the crankcase to either the intake of the internal combustion engine or to the ambient environment of the internal combustion engine, it is possible to prevent excessive and uncontrolled fuel intake to the internal combustion engine if the engine is not running at normal operating conditions. Hence, an advantage is that the present invention enables combustion of the crankcase leakage of the internal combustion engine to both create power and to keep the emissions of the vehicle low in the normal mode of operation of the internal combustion engine. The invention provides for an effective engine runaway protection system and enables a safe use of a fuel vent-free design. Hence, a crankcase ventilation system is provided which guides leaked crankcase fluid to either the intake of the internal combustion engine or to the ambient environment of the internal combustion engine, depending on the engine condition.

Furthermore, the ambient environment of the internal combustion engine should be construed as a position outside of the engine and its associated components. This position does not necessarily have to be e.g. the ambient air; it could equally as well be a waste oil collecting device or any other suitable arrangement for collecting fuel, etc.

According to an example embodiment, it may be determined that the internal combustion engine is exhibiting a normal mode of operation if it is in the mode of operation.

Hereby, the method can discriminate between a mode of operation where the engine is running as expected, i.e. normal mode of operation, and a mode of operation where the engine is not running as expected, i.e. an abnormal mode of operation.

According to an example embodiment, the engine may exhibit normal mode of operation if the measured operation parameter value is within the preset parameter range. An advantage is that a well defined spectrum is provided in which the measured parameter value should be in order to determine that the engine is exhibiting normal mode of operation. If the engine parameter value is above an upper end value of the range, then it is determined that the engine is not exhibiting a normal mode of operation, i.e. it is exhibiting an abnormal mode of operation.

Likewise, it may be determined that the internal combustion does not exhibit a normal mode of operation if the operation parameter value is lower than a lower end value of the preset parameter range. The preset parameter range may, for example, be a range which extends from a lower end point value of e.g. zero up to a specific accepted upper value. In such a case, the engine is exhibiting abnormal mode of operation if the measured parameter value is above the range. Hence, the range is defined by an upper threshold limit and if the measured operation parameter value is above the upper threshold, the engine is exhibiting abnormal mode of operation. According to another example, the range may be a specific value with predetermined tolerances such that the normal mode of operation is defined as being within the tolerances.

According to an example embodiment, the step of guiding the leaked crankcase fluid from the crankcase to the intake of the internal combustion engine may be executed by means of controlling a valve.

Hereby, the valve may be controlled to be positioned in an open state, where leaked crankcase fluid can pass through the valve, or in a closed state where leaked crankcase fluid is prevented from passing through the valve. The valve may be controlled by means of a control unit which further receives information relating to the measured parameter value. Hereby, the control unit can control the valve to be either in the open state or in the closed state depending on the received measured parameter value and the comparison made between the measured parameter value and the preset parameter range. Hence, the control unit may also determine the preset parameter range. As an alternative, the control unit may also be provided with data relating to the preset parameter range from other control unit(s) of the vehicle. According to an example, the valve is normally positioned in the open state.

According to an example embodiment, the valve may be positioned downstream of the crankcase such that it is arranged in fluid communication with the crankcase and the intake of the internal combustion engine.

According to an example embodiment, the step of guiding the leaked crankcase fluid from the crankcase to the ambient environment of the internal combustion engine may be executed by controlling the valve such that a pressure from the crankcase fluid on a relief valve, arranged in fluid communication with the crankcase and the ambient environment, exceeds a predetermined threshold limit.

The relief valve may preferably be controlled by means of the pressure it is exposed to. Hereby, when controlling the above described valve in such a way that leaked crankcase fluid is prevented from passing through the valve, i.e. the valve is positioned in the closed state, the pressure in the relief valve increases to such an extent that it eventually will be positioned in an open state. Hence, the relief valve is preferably positioned in such a way that it is in fluid communication with the crankcase and the valve.

The relief valve may of course, instead of the above described automatically pressure controlled valve, be controlled by means of a control unit in such a way that when leaked crankcase fluid is guided from the crankcase to the ambient environment, the control unit controls the relief valve to be in an open state to allow leaked crankcase fluid to pass there through.

According to an example embodiment, the operation parameter value may be one of crankcase pressure, engine speed and exhaust temperature, or any combination thereof.

These parameters of the internal combustion are well known and easy to measure. Also, when the value of these parameters are not within the range defining normal mode of operation, the leaked crankcase fluid from the crankcase have properties which are not suitable for being provided into the internal combustion engine. It should be readily understood that it may, depending on the specific parameter, be necessary to measure at specific positions in the engine. For example, the exhaust temperature may be different at different positions of the exhaust path and it may thus as such be important to measure the exhaust temperature at a position corresponding to the position of the preset temperature range, i.e. the position where the normal temperature range is determined.

According to a second aspect of the present invention, there is provided a crankcase ventilation system for removing leaked crankcase fluid from a crankcase of an internal combustion engine, the crankcase ventilation system comprising a valve configured to be arranged in fluid communication with a crankcase of the internal combustion engine and an intake of the internal combustion engine; and a control unit connectable to the valve, wherein the control unit is configured to receive an operation parameter value of the internal combustion engine; compare the received operation parameter value with a preset parameter range defining a mode of operation of the internal combustion engine to determine if the internal combustion engine is in the mode of operation; control the valve to guide leaked crankcase fluid from the crankcase to the intake of the internal combustion engine if it is determined that the internal combustion engine is in the mode of operation; and control the valve to guide leaked crankcase fluid from the crankcase to an ambient environment of the internal combustion engine if it is determined that the internal combustion engine is not in the mode of operation.

An advantage of the system according to the second aspect of the present invention is that a combination of an open and a closed crankcase ventilation system is provided. Hence, when leaked crankcase fluid is guided to the intake of the internal combustion engine, the crankcase ventilation system is a closed crankcase ventilation system, whereas when leaked crankcase fluid is guided to the ambient environment, the crankcase ventilation system is an open crankcase ventilation system.

According to an example embodiment, the control unit may be configured to position the valve in an open state if it is determined that the internal combustion engine is in the mode of operation. Hereby, crankcase fluid is guided from the crankcase through the valve and into the intake of the internal combustion engine.

According to an example embodiment, the crankcase ventilation system may further comprise a relief valve configured to be arranged in fluid communication with the crankcase and an outlet to the ambient environment of the internal combustion engine, wherein leaked crankcase fluid from the crankcase is configured to be guided through the relief valve if it is determined that the internal combustion engine is not in the mode of operation.

The relief valve is hence controlled by means of the valve in such a way that when the valve is positioned in a closed state, the leaked crankcase fluid is guided to the relief valve and when the pressure on the relief valve exceeds a threshold pressure, the relief valve opens and the leaked crankcase fluid is guided through the open relief valve and to the ambient environment.

According to an example embodiment, the crankcase ventilation system may further comprise an oil mist separator, wherein the valve is positioned downstream the oil mist separator.

According to an example embodiment, the valve may form an integrated part of the oil mist separator. Hereby, the valve is not in need of individual connection points to e.g. the frame of the vehicle. Accordingly, integrating the crankcase ventilation system with the oil mist separator may thus reduce the overall cost of the crankcase ventilation system since it does not imply additional modifications to the vehicle to which it is connected.

Moreover, also the relief valve may be positioned downstream the oil mist separator. According to an example embodiment, the relief valve may form an integrated part of the oil mist separator.

By arranging the crankcase ventilation system in combination with an oil separator, the leaked crankcase fluid from the crankcase will be relatively clean and free from particles that may negatively affect the environment. Having an oil mist separator thus provides the advantage that the need of an external or additional waste oil collecting device or other arrangement for collecting fuel is reduced.

According to an example embodiment, the crankcase ventilation system may further comprise a pilot valve configured to position the valve in the open or closed state. According to an example embodiment, the pilot valve may be connectable to the control unit and configured to position the valve in the open or closed state as a response to a signal received from the control unit. Furthermore, the pilot valve may also, according to an example, be configured to position the valve in the open or closed state by means of pressure generated in the intake of the internal combustion engine.

An advantage of using a pilot valve is that it further controls the opening and closing of the valve.

Furthermore, the pilot valve may also control other sources of energy of a vehicle, such as e.g. a pneumatic braking system of the engine, etc.

According to an example embodiment, the crankcase ventilation system may further comprise a by-pass valve arranged in fluid communication with the valve and the intake of the internal combustion engine.

The by-pass valve may further prevent undesirable leaked crankcase fluid from entering the intake of the internal combustion engine. Hereby, the by-pass valve may act as a backup valve in case the valve does not function properly. The by-pass valve is adapted to be in a partially closed state when a difference between the pressure in the crankcase and the pressure in the intake of the internal combustion engine is higher than a predetermined threshold pressure value.

Further effects and features of this second aspect are largely analogous to those describe above in relation to the first aspect of the present invention.

According to a third aspect of the present invention, there is provided a control unit electrically connectable to a valve of a crankcase ventilation system of an internal combustion engine, wherein the control unit is configured to receive an operation parameter value of the internal combustion engine; compare the received operation parameter value with a preset parameter range defining a mode of operation of the internal combustion engine to determine if the internal combustion engine is in the mode of operation; control the valve to guide leaked crankcase fluid from the crankcase to the intake of the internal combustion engine if it is determined that the internal combustion engine is in the mode of operation; and control the valve to guide leaked crankcase fluid from the crankcase to an ambient environment of the internal combustion engine if it is determined that the internal combustion engine is not in the mode of operation.

Effects and features of this third aspect are largely analogous to those describe above in relation to the first and second aspects of the present invention.

According to fourth aspect of the present invention, there is provided an internal combustion engine comprising a crankcase ventilation system according to any of the above described example embodiments.

Effects and features of this fourth aspect are largely analogous to those describe above in relation to the first, second and third aspects of the present invention.

According to a fifth aspect of the present invention, there is provided a crankcase ventilation system for removing leaked crankcase fluid from a crankcase of an internal combustion engine, the crankcase ventilation system comprising an oil mist separator configured to be positioned downstream the crankcase and arranged in fluid communication with the crankcase and an intake of the internal combustion engine; and a relief valve configured to be positioned downstream the oil mist separator and arranged in fluid communication with the oil mist separator, the intake of the internal combustion engine, and an ambient environment of the internal combustion engine.

An advantage of the fifth aspect of the present invention is that if the crankcase pressure increases due to e.g. malfunctioning of the crankcase ventilation system, the relief valve will be positioned in an open state due to the increased fluid pressure it is exposed to. Hereby, when the relief valve is positioned in the open state, the crankcase pressure will be reduced and the vehicle will be able to function properly. Also, the fifth aspect of the present invention is especially advantageous in cases where, for example, the conduit to the intake of the internal combustion engine freeze due to cold weather conditions, the relief valve will be exposed to an increased pressure thus being automatically positioned in the open state and allowing leaked crankcase fluid to be guided to the ambient environment since it is not possible, due to the frozen conduit, to guide the leaked crankcase fluid to the intake of the internal combustion engine.

The fifth aspect of the present invention hence provides a closed crankcase ventilation system which can automatically be transformed into an open crankcase ventilation system. Accordingly, the fifth aspect allows the use of a closed crankcase ventilation system even in colder climates where it has previously been preferred to use an open crankcase ventilation system.

Previous solutions of closed crankcase ventilation system have utilized a pressure sensor to warn the driver that the crankcase pressure is increasing. If the driver does not reduce the crankcase pressure the vehicle may not function properly and have to be put into a “limp-home-mode” where it can be fixed.

The fifth aspect of the present invention can of course be combined with any of the above described features in relation to the first, second, third and fourth aspect of the present invention. Advantages of such features in combination with the fifth aspect are largely analogous to the above description.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

The above, as well as additional objects, features and advantages of the present invention, will be better understood through the following illustrative and non-limiting detailed description of exemplary embodiments of the present invention, wherein:

FIG. 1 is a side view of a vehicle comprising an internal combustion engine provided with a crankcase ventilation system according to an example embodiment of the present invention;

FIG. 2 is a schematic view of the crankcase ventilation system according to an example embodiment of the present invention;

FIG. 3 is a graph illustrating an example of measured temperature and preset temperature as a function of time; and

FIG. 4 illustrates a flow-chart of the method steps according to an example embodiment of the present invention.

### DETAIL DESCRIPTION

The present invention will now be described more fully hereinafter with reference to the accompanying drawings, in which an exemplary embodiment of the invention is shown. The invention may, however, be embodied in many different forms and should not be construed as limited to the embodiment set forth herein; rather, these embodiments are provided for thoroughness and completeness. Like reference character refer to like elements throughout the description.

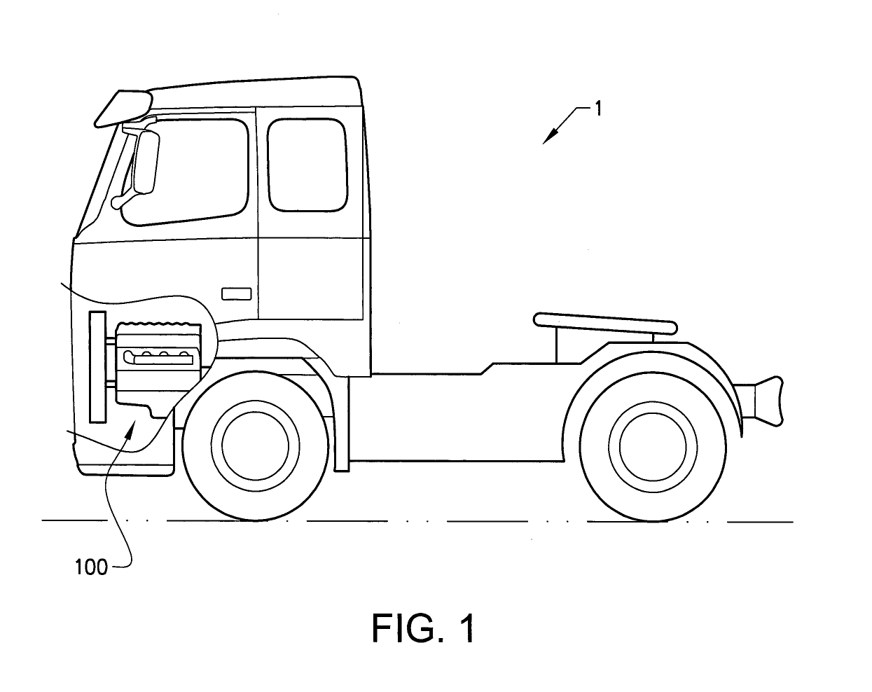

With particular reference to FIG. 1, there is provided a vehicle 1 with an internal combustion engine 100 provided with a crankcase ventilation system according to the present invention. The vehicle 1 depicted in FIG. 1 is a truck for which the inventive internal combustion engine 100 and crankcase ventilation system, which will be described in detail below, is particularly suitable for.

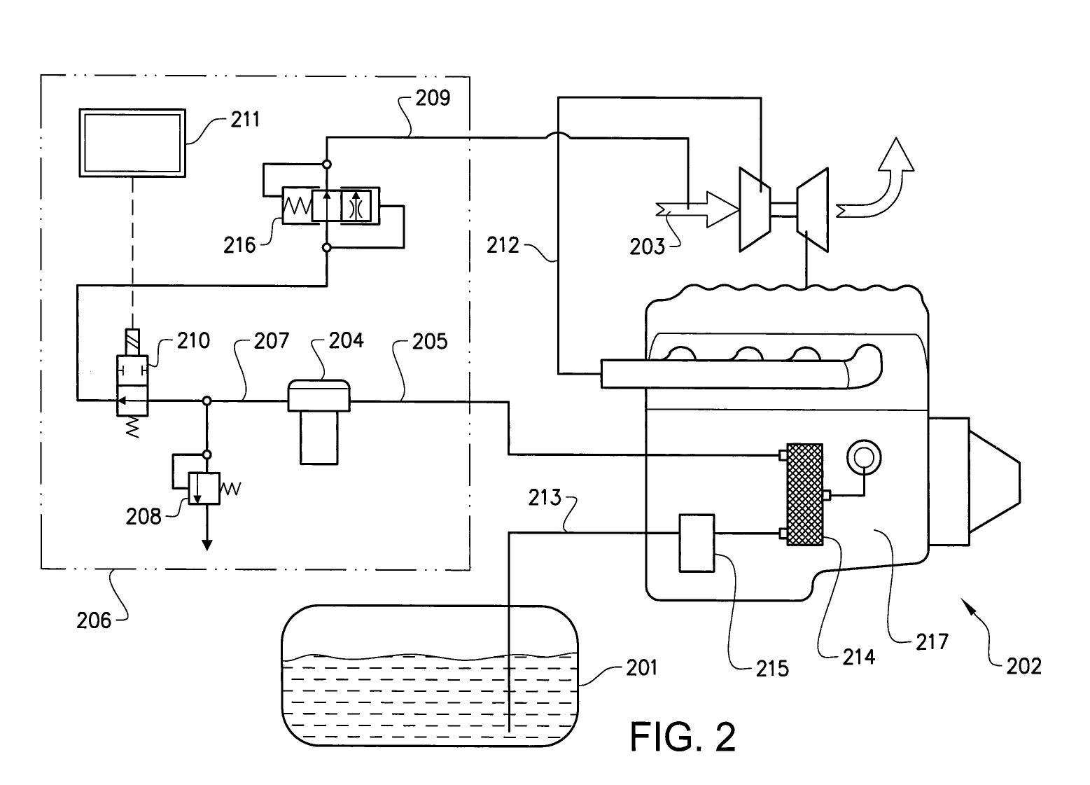

Turning, to FIG. 2, which illustrates an engine system according to an example embodiment of the present invention. The engine system comprises a fuel system 201. The fuel system 201 may contain any fuel that is suitable for the specific engine type. Hence, the fuel system 201 may comprise diesel, petrol, ethanol, dimethyl ether (DME), etc. The invention should thus not be limited to any specific type of fuel propelling the engine. Further, the engine system comprises a cylinder arrangement 202 having a crankcase 217 housing a crank axle connected to a plurality of pistons via respective connecting rods. Fuel from the fuel tank 201 is guided to the engine via an oil trap 214. According to an example and as depicted in FIG. 2, an additional oil trap 215 may be positioned between the oil trap 214 and the fuel tank 20.

Moreover, the engine system comprises a crankcase ventilation system 206, which will be described in detail below, and a turbo unit comprising a turbine and a compressor. More specifically, a conduit 209 connects the crankcase ventilation system 206 to an intake 203 of the internal combustion engine, and further through an inlet and into the internal combustion engine.

Now, reference is made to the crankcase ventilation system 206 of the present invention which is illustrated in FIG. 2. The crankcase ventilation system 206 comprises, according to the non-limiting example depicted in FIG. 2, an oil mist separator 204, a relief valve 208, a valve 210 electrically connected to a control unit 211, and an optional by-pass valve 216. The oil mist separator 204 is connected to a blow-by path 205 and arranged downstream of the crankcase. The relief valve 208 is further arranged downstream the oil mist separator 204 in fluid communication with the oil mist separator 204 and an ambient environment of the internal combustion engine. The relief valve 208 should be interpreted as a valve which is positioned in an open state when it is exposed to a pressure exceeding a predefined pressure limit. Also, the valve 210 is arranged downstream the oil mist separator 204 and arranged in fluid communication with the oil mist separator and the intake 203 of the internal combustion engine. Finally, the optionally arranged by-pass valve 216 is positioned downstream the valve 210 and in fluid communication with the valve 20 and the intake 203 of the internal combustion engine.

Furthermore, the valve 210 may be a controllable valve, which is positioned in an open state or a closed state by means of a signal from the control unit 211. The controllable valve may, for example, be a two-way valve.

The following will now describe the function of the crankcase ventilation system 206, and the associated method, in further detail. Reference is thus made to FIGS. 2-4.

When there is fluid leakage formed in the crankcase 217 from e.g. the combustion process of the internal combustion engine, this crankcase fluid leakage is directed out from the crankcase through the blow-by path 205 and directed into the oil mist separator 204. In the oil mist separator 204 the leaked crankcase fluid is provided to a separation process such that the fluid leaving the oil mist separator 204 is free, or relatively free, from particles that may negatively affect the environment. Hence, the fluid leaving the oil mist separator 204 into the conduit 207 is relatively clean. The leaked crankcase fluid may thereafter be guided to either the valve 210 or to the relief valve 208.

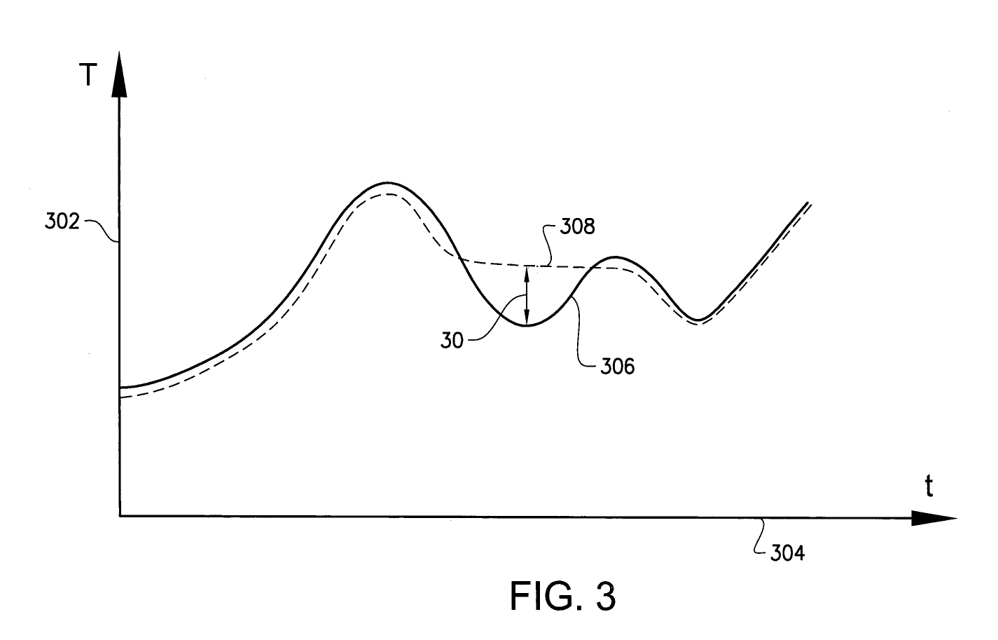

In order to determine if the leaked crankcase fluid is to be guided through the valve 210 or through the relief valve 208, the invention determines if the internal combustion engine is operating according to a normal mode of operation or to an abnormal mode of operation. This determination is illustrated in FIG. 3 where an example relating to the exhaust temperature 302 over time 304 is given. Hence, FIG. 3 illustrates the exhaust temperature variation over time when the vehicle is running. It should be noted that the depicted graph in FIG. 3 only serves for illustrative purposes.

The solid line 306 in FIG. 3 illustrates the preset parameter range 306 over time 304, in the illustrated embodiment the expected exhaust temperature variation over time according to a specific operating condition. The depicted solid line illustrates a specific temperature value for each point in time, but it should be readily understood that this preset value have some tolerances thus providing a temperature range for each point in time, i.e. a maximum and a minimum temperature value for each poinT in time. Accordingly, the preset parameter range 306 in FIG. 3 illustrates an expected exhaust temperature, based on the specific driving condition of the vehicle. Hence, the preset parameter range 306 defines the temperature range of the expected exhaust temperature under a normal operating mode.

The dotted line 308 in FIG. 3 illustrates the measured parameter value 308, in the example a measured exhaust temperature at different points in time. The measured temperature 308 is below the expected temperature 306 during almost the entire time period illustrated in FIG. 3. However, at a specific point in time, the measured temperature 308 is increased in relation to the expected temperature 306. The difference 30 between the measured temperature 308 and the expected temperature 306 is measured. Hereby, if the difference 30 between the measured temperature 308 and the expected temperature 306 is larger than a threshold temperature value, it is determined that the internal combustion engine is not exhibiting a normal mode of operation, i.e. the internal combustion engine is exhibiting an abnormal mode of operation. The determination that the internal combustion engine is exhibiting an abnormal mode of operation may also, instead of comparing the difference 30 to a threshold, be based on the fact that the measured temperature is higher than an upper end value of the temperature range. Hence, it suffices that the temperature is higher than expected to determine that the internal combustion engine is exhibiting an abnormal mode of operation.

Although FIG. 3 is depicted and described in relation to the exhaust temperature, other parameters are of cause also valid for determining if the internal combustion engine is exhibiting normal or abnormal mode of operation, such as crankcase pressure, engine speed, etc. These parameters may be measured and compared individually or in combination with each other.

When it is determined that the measured exhaust temperature is larger than normal, i.e. the difference 30 between the measured exhaust temperature 308 and the expected exhaust temperature 306 is larger than the preset threshold temperature value, it is determined that the crankcase is not exhibiting a normal mode of operation. Accordingly, the internal combustion engine exhibits an abnormal mode of operation. Hereby, and referring back to FIG. 2, the control unit 211 provides a signal to the valve 210 such that the valve 210 is arranged in a closed state which does not allow leaked crankcase fluid from the crankcase 217 to pass through the valve 210. The leaked crankcase fluid will then instead be guided to the relief valve 208. The relief valve 208 is in a normally closed state meaning that in its normal state it does not allow leaked crankcase fluid to pass there through. However, when the valve 210 is closed, the relief valve 208 will be exposed to increased pressure due to the pressure from the leaked crankcase fluid. When the pressure on the relief valve 208 has exceeded a certain limit, the relief valve 208 will be arranged in an opened state, thereby guiding the leaked crankcase fluid through the relief valve 208 and to the ambient environment of the internal combustion engine 100.

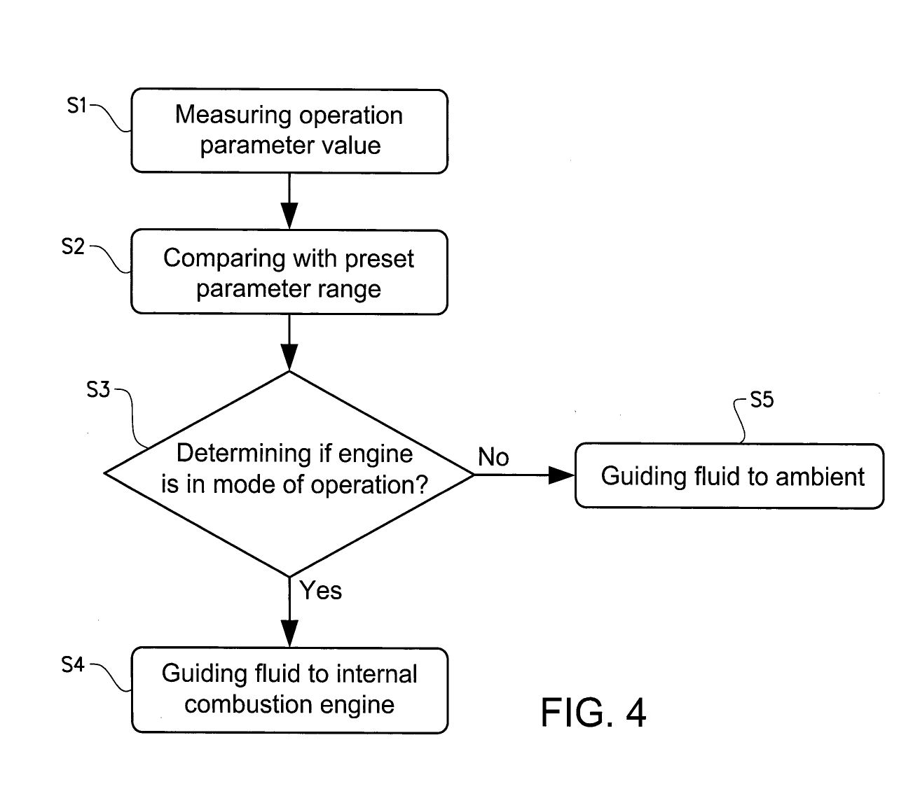

Reference is finally made to FIG. 4 which illustrates a flow chart of the method according to an example embodiment of the present invention. According to a first step of the method, an operation parameter value is measured S1. Hereby, a value of a parameter of the internal combustion engine is measured. Since it is clear from the inventive concept of the present application that the parameter value is measured when the engine is running, the parameter value may be continuously measured during operation of the internal combustion engine. Thereafter, the measured S1 parameter value 308 is compared S2 with a preset parameter range. The preset parameter range 306 is a range for the same parameter that was measured in the previous step and is a range that defines a mode of operation of the internal combustion engine. Accordingly, the preset parameter range 306 is dependent on the specific operation of the vehicle and defines a mode of operation based on this specific operation of the vehicle. For example, the preset temperature range 306 described and depicted above in the example embodiment in relation to FIG. 3 can have different proportions/temperature values if the vehicle is running upwards in a steep hill compared to driving the vehicle on a straight and level road.

Thereafter, it is determined S3 if the internal combustion engine is in the mode of operation. This determination is made by comparing the measured parameter value 308 with the preset parameter range 306. Referring again to the example depicted in FIG. 3, the compared difference 30 between the measured temperature 308 and the preset parameter range 306, i.e. the expected exhaust temperature range, is at a point in time higher than a predetermined threshold value. At this depicted point in time, it is determined that the internal combustion engine is not in the mode of operation, i.e. it is exhibiting an abnormal mode of operation.

The method is thereafter followed by the step of guiding S4 the leaked crankcase fluid from the crankcase 217 of the internal combustion engine 00 to the intake of the internal combustion engine if it is determined that the internal combustion engine is in the mode of operation. According to an example embodiment, the step of guiding the leaked crankcase fluid is executed by positioning the valve 210 in an open state such that leaked crankcase fluid can be guided from the crankcase 27, through the valve 210, and into the internal combustion engine 100.

However, if the internal combustion engine is not in the mode operation, leaked crankcase fluid is instead guided S5 to the ambient environment of the internal combustion engine. According to an example embodiment, this step is executed by closing the valve 210 such that leaked crankcase fluid is guided through the relief valve 208, which is forced to be positioned in an open state due to the pressure it is exposed to from the leaked crankcase fluid, and to the ambient environment of the internal combustion engine.

It should be noted that the invention works equally as well by switching position of the valve 210 and the relief valve 208. In such a case, the valve 210 should be positioned in the closed state to guide leaked crankcase fluid to the intake of the internal combustion engine via the relief valve 208, and in an open state to guide leaked crankcase fluid from the crankcase 217 to the ambient environment of the internal combustion engine 100.

According to a case where the valve 210, control unit 211 and by-pass valve 216 is removed from the above described crankcase ventilation system, i.e. the crankcase ventilation system only comprises the oil mist separator 204 and the relief valve 208. In such a case, leaked crankcase fluid is guided from the crankcase 217 to the intake 203 of the internal combustion engine 100 during normal mode of operation. However, in the case the conduit 209, for example, freeze due to low temperature where the vehicle is driving or is being clogged, such that leaked crankcase fluid is prevented from being guided all the way to the intake 203 of the internal combustion engine, the gas pressure in the conduit 209 will increase and when the pressure has exceeded a certain threshold value, the relief valve 208 will be positioned in an open state to guide leaked crankcase fluid there through. Hereby, the crankcase ventilation system will be transformed from a closed crankcase ventilation to an open crankcase ventilation system, such that the crankcase ventilation system is vented.

It is to be understood that the present invention is not limited to the embodiments described above and illustrated in the drawings; rather, the skilled person will recognize that many changes and modifications may be made within the scope of the appended claims. For example, the by-pass valve describe is not essential for the overall functioning of the crankcase ventilation system. Also, the crankcase ventilation system should not be construed as limited to the use of an oil mist separator. The invention functions equally well without the oil mist separator or with another component replacing the oil mist separator but providing a similar function to the system.

1. A method for removing leaked crankcase fluid from a crankcase (217) of an internal combustion engine (100) during operation thereof, the method comprising the steps of:
measuring (S1) an operation parameter value (308) of the internal combustion engine (100);
comparing (S2) the measured operation parameter value (308) with a preset parameter range (306) defining a mode of operation of said internal combustion engine (100) for determining (S3) if said internal combustion engine is in the mode of operation;
guiding (S4) said leaked crankcase fluid from the crankcase (217) to an intake (203) of the internal combustion engine if it is determined that said internal combustion engine is in the mode of operation; and
guiding (S5) said leaked crankcase fluid from the crankcase (217) to an ambient environment of the internal combustion engine if it is determined that said internal combustion engine is not in said mode of operation.

2. The method according to claim 1, wherein it is determined that said internal combustion (100) engine is exhibiting a normal mode of operation if it is in said mode of operation.

3. The method according to claim 2, wherein the engine exhibits normal mode of operation if the measured operation parameter value is within said preset parameter range (306).

4. The method according to any of the previous claims, wherein the step of guiding (S4) the leaked crankcase fluid from the crankcase (217) to the intake (203) of the internal combustion engine (100) is executed by means of controlling a valve (210).

5. The method according to claim 4, wherein the valve (210) is positioned downstream of said crankcase (217) such that it is arranged in fluid communication with the crankcase (217) and the intake (203) of the internal combustion engine (100).

6. The method according to any one of the preceding claims, wherein the step of guiding (S5) the leaked crankcase fluid from the crankcase (217) to the ambient environment of the internal combustion engine (100) is executed by controlling the valve (210) such that a pressure from the crankcase fluid on a relief valve (208), arranged in fluid communication with the crankcase (217) and the ambient environment, exceeds a predetermined threshold limit.

7. The method according to any one of the preceding claims, wherein the operation parameter value is one of crankcase pressure, engine speed and exhaust temperature, or any combination thereof.

8. A crankcase ventilation system (206) for removing leaked crankcase fluid from a crankcase (217) of an internal combustion engine (100), the crankcase ventilation system (206) comprising: a valve (210) configured to be arranged in fluid communication with a crankcase (217) of the internal combustion engine (100) and an intake (203) of the internal combustion engine (100); and a control unit (211) connectable to said valve (210), wherein said control unit (211) is configured to:
receive an operation parameter value (308) of the internal combustion engine (100);
compare the received operation parameter value (308) with a preset parameter range (306) defining a mode of operation of said internal combustion engine (100) to determine if said internal combustion engine (100) is in the mode of operation;
control said valve (210) to guide leaked crankcase fluid from the crankcase (217) to the intake (203) of the internal combustion engine (100) if it is determined that the internal combustion engine (100) is in the mode of operation; and
control said valve (210) to guide leaked crankcase fluid from the crankcase (100) to an ambient environment of the internal combustion engine (100) if it is determined that the internal combustion engine is not in the mode of operation.

9. The crankcase ventilation system (206) according to claim 8, wherein the control unit (211) is configured to position the valve (210) in an open state if it is determined that the internal combustion engine (100) is in the mode of operation.

10. The crankcase ventilation system (206) according to claim 8 or 9, further comprising a relief valve (208) configured to be arranged in fluid communication with the crankcase (217) and an outlet to the ambient environment of the internal combustion engine (100), wherein leaked crankcase fluid from the crankcase (217) is configured to be guided through the relief valve (208) if it is determined that the internal combustion engine (100) is not in the mode of operation.

11. The crankcase ventilation system (206) according to any one of claims 8-10, further comprising an oil mist separator (204), wherein the valve (210) is positioned downstream said oil mist separator (204).

12. The crankcase ventilation system (206) according to claim 11, wherein the valve (210) forms an integrated part of the oil mist separator (204).

13. The crankcase ventilation system (206) according to claim 11 when dependent on claim 10, wherein the relief valve (208) is positioned downstream the oil mist separator (204).

14. The crankcase ventilation system (206) according to claim 11 when dependent on claim 10, wherein the relief valve (208) forms an integrated part of the oil mist separator (204)

15. The crankcase ventilation system (206) according to claims 8-14, further comprising a pilot valve configured to position the valve (210) in the open or closed state.

16. The crankcase ventilation system (206) according to claim 15, wherein the pilot valve is connectable to the control unit (211) and configured to position the valve (210) in the open or closed state as a response to a signal received from the control unit (211).

17. The crankcase ventilation system (206) according to claim 15, wherein the pilot valve is configured to position the valve (210) in the open or closed state by means of pressure generated in the intake (203) of the internal combustion engine.

18. The crankcase ventilation system (206) according to any one of claims 8-17, further comprising a by-pass valve (216) arranged in fluid communication with the valve (210) and the intake (203) of the internal combustion engine (100).

19. A control unit (211) electrically connectable to a valve (210) of a crankcase ventilation system (206) of an internal combustion engine (100), wherein the control unit (211) is configured to:
receive an operation parameter value (308) of the internal combustion engine (100);
compare the received operation parameter value (308) with a preset parameter range (306) defining a mode of operation of said internal combustion engine (100) to determine if said internal combustion engine (100) is in the mode of operation;
control said valve (210) to guide leaked crankcase fluid from the crankcase (217) to an intake (203) of the internal combustion engine (100) if it is determined that the internal combustion engine is in the mode of operation; and
control said valve (210) to guide leaked crankcase fluid from the crankcase (217) to an ambient environment of the internal combustion engine (100) if it is determined that the internal combustion engine is not in the mode of operation.

20. An internal combustion engine (100), comprising a crankcase ventilation system (206) according to any one of claims 8-18.

21. A crankcase ventilation system for removing leaked crankcase fluid from a crankcase (217) of an internal combustion engine (100), the crankcase ventilation system comprising:
an oil mist separator (204) configured to be positioned downstream the crankcase (217) and arranged in fluid communication with the crankcase (217) and an intake (203) of the internal combustion engine (100); and
a relief valve (208) configured to be positioned downstream the oil mist separator (204) and arranged in fluid communication with the oil mist separator (204), the intake (203) of the internal combustion engine (100), and an ambient environment of the internal combustion engine (100).
